(19) United States
(12) Patent Application Publication
(10) Pub. No.: US 2007/0027783 A1
(43) Pub. Date: Feb. 1, 2007

(54) Exposure exchange

(76) Inventor: Stephen J. Meyer, Smith's Parish (BM)

Correspondence Address: SEYFARTH SHAW LLP, 131 S. DEARBORN ST., SUITE2400, CHICAGO, IL, 60603-5803, US

(21) Appl. No.: 11/192,207

(22) Filed: Jul. 28, 2005

(51) Int. Cl. G06Q 40/00; G06F 17/30; G06F 7/00

(52) U.S. Cl. 705/35; 707/3

(57) ABSTRACT

An exposure exchange and method of operation therefore. An offer is received from a first party to assume exposure to at least one type of catastrophic risk in exchange for another party assuming exposure to at least one other type of catastrophic risk. A database is searched for an offer from a second party that is compatible with the first party's offer.

### BACKGROUND

In the insurance business, it is important that individual insurers do not accept accumulated risk to a particular event that outstrips the insurer's ability to pay the individual claims resulting from such an event. For example, if an insurer accepts $20 mm in aggregate exposure to an earthquake in a particular earthquake zone, then it is important that the insurer has the means to pay $20 mm in claims if such an earthquake occurs.

Quite often, insurers are not willing to accept the full amount of the exposure they carry to a particular event. For instance, the insurer in the previous example, with $20 mm in earthquake exposure might only want to accept a $10 mm loss in a single earthquake. Traditionally, insurers have managed their aggregate exposure to through the purchase of reinsurance. Reinsurance is essentially a vehicle by which an insurer transfers a portion of risk to another party, i.e. the reinsurer. Thus, to cover $20 mm in earthquake risk, the previous insurer could, on its own, retain $10 mm in risk and transfer the remaining $10 mm in risk to a reinsurer.

Reinsurance, however, has several drawbacks that can disrupt the primary insurance market. Primary insurers cannot always rely on a steady supply of reinsurance. The supply of reinsurance often dries up, thereby resulting in reinsurance being either unavailable or only available at high cost. Even when reinsurance is available, primary insurers often have to ask the reinsurer for permission to write additional exposures or purchase additional reinsurance to write additional exposures. This reduces the primary insurer's ability to react quickly to market opportunities and reduces competition.

Accordingly, what is needed is an exposure exchange, which allows insurers to reduce their aggregate exposure to certain types of risk without suffering the drawbacks of reinsurance.

### SUMMARY

In one example, a method is provided. An offer is received from a first party to assume exposure to at least one type of catastrophic risk in exchange for another party assuming exposure to at least one other type of catastrophic risk. An offer database is searched for an offer from a second party that is compatible with the first party's offer.

In another example, an article is provided. A computer-readable signal-bearing medium is provided. Logic in the medium can receive an offer from a first party to assume exposure to at least one type of catastrophic risk in exchange for another party assuming exposure to at least one other type of catastrophic risk. Logic in the medium can search an offer database for an offer from a second party that is compatible with the first party's offer.

In a further example, a system is provided. An offer database includes at least one offer from a party to assume exposure to at least one type of catastrophic risk in exchange for another party assuming exposure to at least one other type of catastrophic risk. An interface receives offers to trade exposure to catastrophic risks, and a search engine matches received offers to trade catastrophic risks to offers in the offer database.

In yet another example, a method is provided. An offer is sent to an exchange agreeing to assume exposure to at least one type of catastrophic risk in exchange for another party assuming exposure to at least one other type of catastrophic risk. A communication is received from the exchange providing results from a search of an offer database for an offer from a second party that is compatible with the offer.

### BRIEF DESCRIPTION OF THE DRAWINGS

FIG. 1 is a depicts one example of an exposure exchange.

FIG. 2 is a functional block diagram depicting exemplary operation of the exposure exchange of FIG. 1.

FIG. 3 shows an exemplary web page that can be utilized to input information into the exposure exchange of FIG. 1.

FIG. 4 depicts representative data structures for two users of the exposure exchange of FIG. 1.

### DETAILED DESCRIPTION

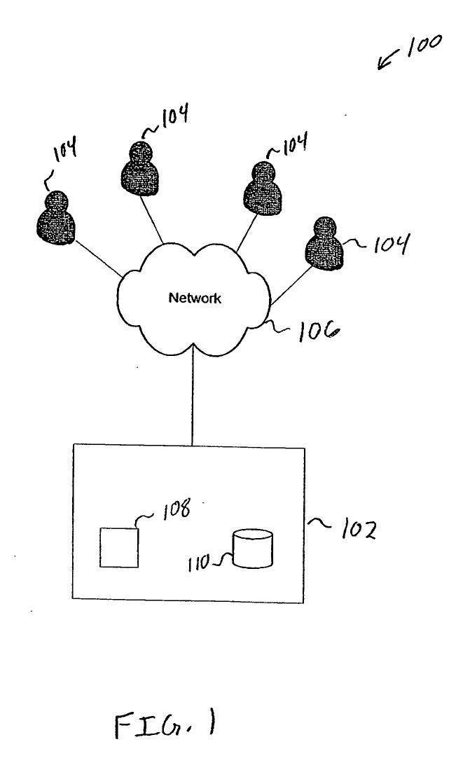

Referring to FIG. 1, an exemplary diagram showing the exposure exchange 100 is provided. The exposure exchange 100 allows participants to swap exposures to events, such as earthquakes, hurricanes, terrorism, fires, and so on. The exposure exchange addresses particular needs in the current insurance marketplace.

In the current marketplace, certain exposures periodically become uninsurable or the costs to insure certain risks becomes prohibitively high. An exposure may be uninsurable for several reasons: for individual insurers, it may be uninsurable because it would be imprudent for that insurer to take on additional aggregate exposure to a single event, while for industry as a whole, it may be because the absolute frequency and/or severity of a single event may be unknown, so that it is impossible to calculate the expected loss costs for a policy covering such an event, or there are so many potential claims from an single incident that the industry lacks the capacity to absorb all of those potential claims.

To manage the first of above two conditions, most insurers have entire departments whose sole function is to monitor how much exposure has been written for certain types of events and to ensure that the amounts written are within the insurer's tolerance, are within the agreements the insurers have with reinsurers, and/or that the insurers have adequate reinsurance coverage. If these limits are exceeded, the insurer must purchase additional reinsurance or put a moratorium on writing new business.

The second of the above conditions is seen from time to time for such exposures as California Earthquake, Florida Hurricane, and Terrorism. Much of the reason that the industry lacks the capacity for certain exposures is that the reinsurance mechanism tends to aggregate these exposures at the reinsurance level rather than spread them.

The exposure exchange provides risk bearers with an avenue to diversify their risk portfolios by swapping exposures with other insurers who have unrelated exposures. For example, a regional insurer with too much exposure to Florida windstorms can swap all or some of that exposure to another regional insurer who has too much exposure to another catastrophic event, such as a California earthquake. This could be accomplished by a symmetrical swap, e.g. Company F takes on $X of California earthquake exposure in exchange for Company C taking on $X of Florida hurricane exposure. Alternatively, this could be accomplished with an asymmetrical swap. That is, one company could take on greater or lesser exposure than the other company.

The users of the exchange are risk bearing entities. Risk bearing entities include insurance companies. However, the exchange is not limited to insurance companies. Noninsurers could also use the exchange. For instance, virtually all major corporations and municipalities have exposure to catastrophic risks. The main qualification for participation is that the risk bearing entity have a satisfactory ability to pay for its “swapped in” exposures (as determined by the rules of the exchange) in the event of a loss trigger.

This application will describe certain types of exposures that the users can swap by using the exchange. The event types described are hurricanes, earthquakes, terrorism, and so forth. However, the exchange is not limited to such events. Exposure to any type of risk could be swapped in the exchange. For instance, exposure to workers compensation claims could be swapped. As will be discussed herein, the only criteria for an exposure to be swappable is that the event causing the exposure must have a trigger, which is acceptable to the users of the exchange, that will identify when an event has actually occurred, thereby resulting in users having to cover certain exposures.

It should be understood that events can be classified in a number of ways. For example, an earthquake can be classified as Mag 7.5 or more, Mag 7.0 or more, Mag 6.5 or more, etc. Hurricanes can be classified as Category 5, Category 4, Category 3, etc. Events can also be classified by location, e.g. Florida hurricane vs. non-Florida hurricane, California earthquake vs. Japanese earthquake, etc. Once again, the governing authority of the exchange will determine what exposures are swappable and how to categorize each exposure.

This application will describe swaps between two parties, but it should be understood that the exchange could also cover swaps between multiple parties.

This application will describe, for illustrative purposes, relatively simple swaps. It should be understood, however, that the exchange could also accommodate more complicated swaps. For instance, Party C may not want to swap exposure to an earthquake of magnitude 7 or above for exposure to a hurricane because the likelihood of a hurricane may seem greater than a large quake. The exchange could provide Party C with the option of swapping for an earthquake of lower magnitude.

This application will describe relatively even swaps. It should be understood, however, that the exchange could also operate to allow uneven swaps. For instance, after a major earthquake, many primary insurers, who have exhausted their aggregates reinsurance protection, have problems obtaining reinsurance because it is well known that there is a heightened probability of an earthquake after a major earthquake. It is contemplated that the exchange could allow insurers, who have exhausted their aggregates after a catastrophic event, to find partners willing to take on this exposure, albeit at a relatively high price, e.g. half a year of quake coverage in exchange for a full year of another exposure. Users can also use the exchange to swap asymmetrical monetary amounts. For instance, $10 mm in exposure to one type of event in exchange for $20 mm in exposure to another type of event.

It is also contemplated that the exchange could handle multiple event swaps. This would allow smaller companies, who would be impaired if they had to pay on more than one catastrophe in a given time period, to offload this risk.

The exchange should have a governing entity that sets the rules and regulations of the exchange. Rules include, but are not limited to, the types of events that users are allowed to swap, minimum amounts of swaps, whether uneven swaps are permitted, time periods for swaps, whether membership fees are required to use the exchange, whether a fee for each swap is charged, whether the identities of the participants are know to each other, the triggers for each event, and so on. The rules of the exchange could be formed in a wide variety of ways. The owner of the exchange could set the rules. The members of the exchange could form a governing council that sets the rules. The members could vote on the rules. It should be understood that the present application is not limited to a particular governing structure.

Referring to FIG. 1, the exchange 100 in one example includes a server 102. The server 102 can be connected to at least one or more user entities 104 through a network 106. The network 106 in one example includes any network that allows multiple computing devices to communicate with one another (e.g., a Local Area Network (“LAN”), a Wide Area Network (“WAN”), a wireless LAN, a wireless WAN, the Internet, a wireless telephone network, etc.) In a further example, the network 106 comprises a combination of the above mentioned networks. The computing device can be connected to the network through landline (e.g., T1, DSL, Cable, POTS) or wireless technology, such as that found on mobile telephones, PDA devices, or used in wireless LAN and wireless WAN networks.

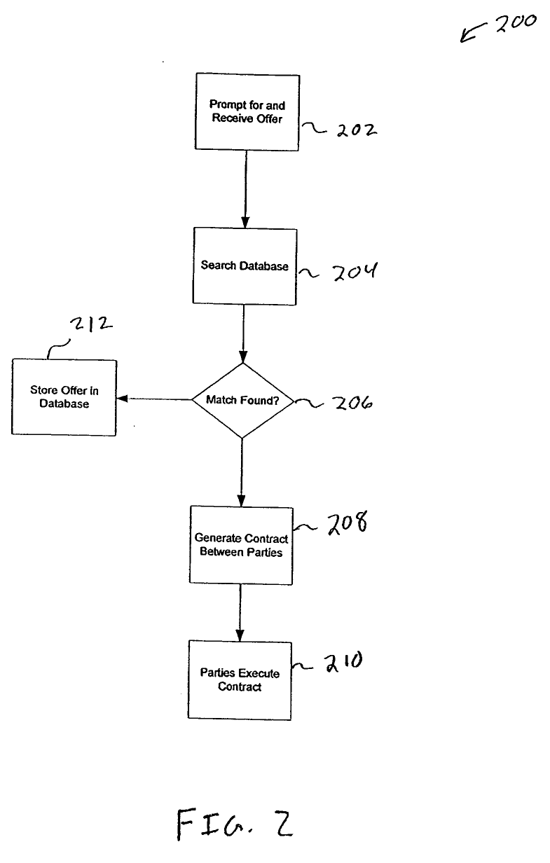

FIG. 2 depicts a method 200 by which the exchange 100 is utilized to allow users to swap insurance exposures. The method 200 in one example is performed on server 102. In another example, the method 200 can be performed on another type of computing device or system. For example, the computing device could be a personal computer, a workstation, a file server, a mainframe, a personal digital assistant (“PDA”), a mobile telephone, or a combination of these devices. In the case of more than one computing device, the multiple computing devices could be coupled together through the network 106.

Referring to FIG. 1, the server 102, or whatever computing device is utilized, includes one or more logic components such as computer software and/or hardware components to carry out the process 200. A number of such components can be combined or divided. An exemplary component employs and/or comprises a series of computer instructions written in or implemented with any of a number of programming languages, as will be appreciated by those skilled in the art.

In one example, the method 200 is embedded in an article including at least one computer-readable signal-bearing medium. One example of a computer-readable signal-bearing medium is a recordable data storage medium such as a magnetic, optical, and/or atomic scale data storage medium. In another example, a computer-readable signal-bearing medium is a modulated carrier signal transmitted over a network comprising or coupled with computing device or system, for instance, a telephone network, a local area network (“LAN”), the Internet, and/or a wireless network.

Referring further to FIG. 1, the server 102 in one example includes a database 108 which contains information for each user entity 104. Such information includes, but is not limited to, information, such as the identity of the user entity 104, any relevant account information (e.g. user names, account passwords), offers to swap exposure to particular catastrophic events, and the status of swaps that have already taken place. Search logic 110 can search database 108 for a particular offer or can search database 108 to find compatible offers.

Referring further to FIG. 1, the user entities 104 utilize the exchange 100 to swap exposures to events. To initiate a swap the user will access server 102 through network 106. In one example, the user entity accesses a web page and initiates the swap by sending information to the server 102 through the web page. In another example, the user entity 104 transmits information through another means, such as email, instant messaging, or a voice communication to the server 102 through network 106.

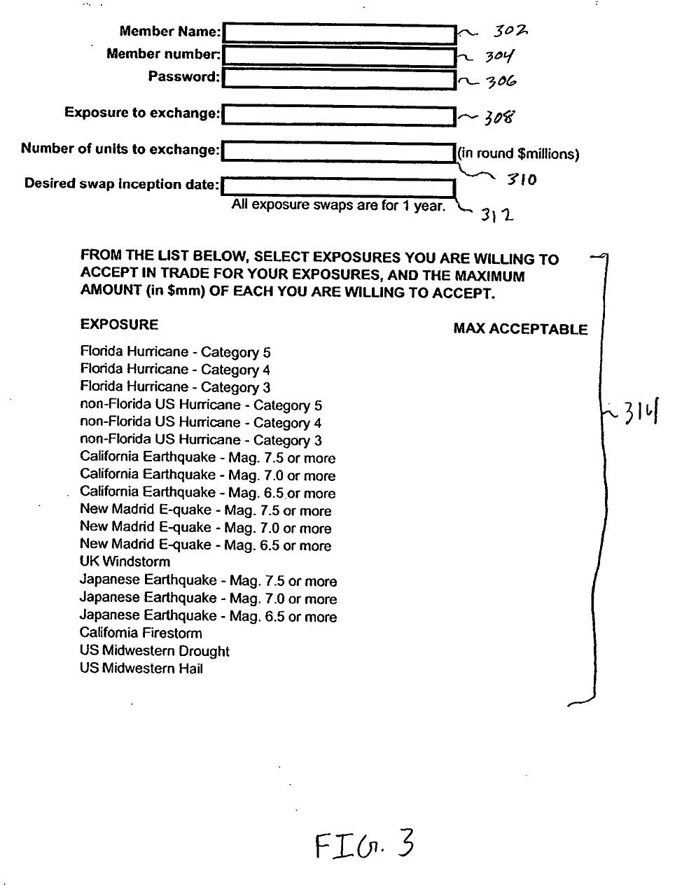

FIG. 3 shows an exemplary web page for a user entity to enter information to initiate a swap. The web page includes entry boxes for member name 302, member number 304, password 306, the type of exposure to exchange 308, the amount to exchange 310, the swap inception date 312, and the amount of exposure to incur for each type of risk 314. When a number of user entities provide the exchange with this data, database 110 will contain several data structures, which include the swap offers for each user. Search logic 108 can then match compatible offers.

The preceding description is not meant to limit the parameters that can be used in swaps. For instance, the exchange 100, the user entities 104, or a combination of the two can determine mandatory exchange parameters or parameters that are left to the user entities' 104 discretion. The exchange could limit the swaps to a particular duration, e.g. one year, or to symmetrical swaps (equal dollar amounts) only. The exchange could also limit the event types to a predetermined number, e.g. Florida hurricanes, California earthquakes, or New York City terrorism.

The user entities could limit on the types of swaps in which the users entities 104 are willing to participate. For instance, a user entity 104 could specify that it will only accept swaps from U.S. companies, from insurance companies, or from entities with an S&P rating exceeding a certain level.

The only criteria for an exposure to be subject to a swap is that there be a trigger that is acceptable to the user entities 104 that confirms when an event has occurred. One example of a trigger is a report from a disinterested third party that indicates the occurrence of an event. For instance, the trigger for a hurricane of a particular magnitude could be a report by the US weather service. An earthquake trigger could be a report by the US Geological Service. A terrorism trigger could be a report by the US Department of Homeland Security. When a trigger occurs, the users must then complete the terms of the swap. The exchange 100 in one example, will have the responsibility of providing a trigger for each type of event for which the exchange allows swaps to occur.

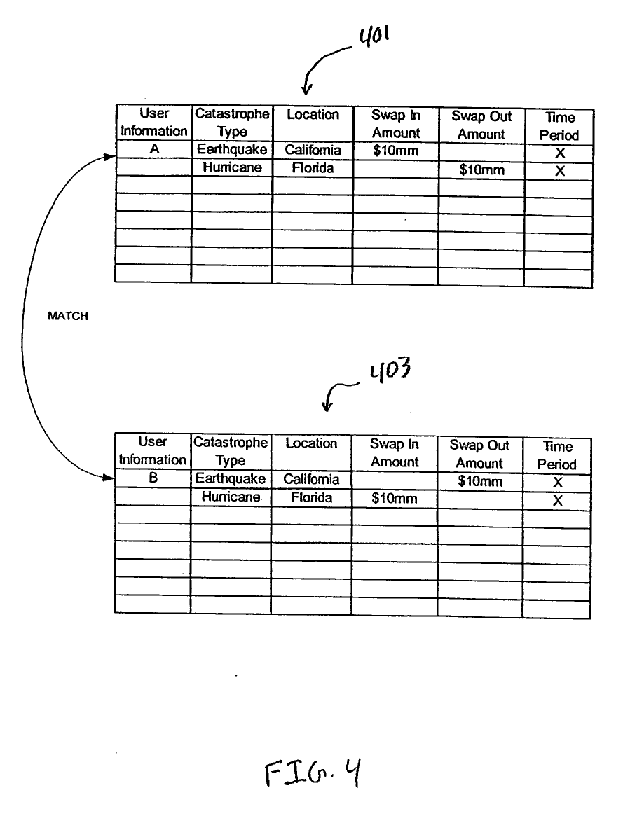

Referring to FIG. 4, after a user entity 104 sends a swap offer to the exchange, the swap offer resides in the database 1 10. FIG. 4 shows two data structures 401 and 403 containing swap information for User A and User B, respectively. The information stored has been simplified for illustrative purpose, but it should be understood that the information can be as detailed as the exchange requires.

Referring now to FIG. 2, the method 200 by which the user entities 104 use the exchange 100 will now be described for illustrative purposes. In step 202, the exchange 100 will prompt for and receive an offer from a first party to exchange an exposure. The offer could take many forms depending on the exchange's 100 governing structure. In one example, a user entity 104 could log into the exchange using a web browser and send the terms of the swap offer to the server 102 through a web page.

In step 204, the search logic 108 searches database 110, for compatible offers. In step 206, the search logic 108 determines whether a match was found. If a match is found (see FIG. 4), then in step 208, the exchange 100 generates a contract between the two user entities 104 having compatible offers. In step 210, the user entities 104 execute the contract.

The contract could be quite simple, i.e. “User Entity A agrees to pay User Entity B the sum of $X if a catastrophe of a first type occurs from a first date to a second date in return for User Entity B agreeing to pay User Entity A the sum of $X if a catastrophe of a second type occurs from the first date to the second date.” Alternatively, the contract could be more complicated if the users or the management of the exchange 100 so require. As another alternative, the exchange 100 could keep the parties' identities secret and act as a go between. In such a case, the contract would necessarily be of a different form.

If a match is not found, then in step 212, the swap offer is stored in the database 110 until a match is found, the offer expires, or the user entity 104 asks that it be removed. If multiple matches occur, the exchange 100 can provide the user entities 104 with the opportunity to select which offer they prefer to select.

In another embodiment, the catastrophic exposure exchange 100, in addition to categorizing catastrophic events by type, severity, and location, could also categorize events by frequency, or perceived frequency. In this embodiment, those who manage the exchange 100 would divide the geographical world map into isomorphic zones, i.e. areas in which the probability of a particular trigger would be equal to the desired market frequency α. The desired market frequency a is the likeliness of a particular event occurring. For example, the a given exchange 100 could specify desired market frequency αvalues of once in 30 years, once in 100 years, and once in 250 years. Accordingly, the exchange 100 will provide zones for each of these frequencies. For illustrative purposes only, Tables 1 through 3 provide an exemplary mapping for each frequency:

TABLE 1
One Event Each 30 Years (Probability Level 1)

| | | Area | |
|---|---|---|---|
| Country | State/Other | Description | Event Description |
| Japan | Tokyo | Territory 1 | Earthquake magnitude 7.0 or more |
| Japan | Kobe | Territory 2 | Earthquake magnitude 6.5 or more |
| US | California | Territory 1 | Earthquake magnitude 6.9 or more |
| US | California | Territory 2 | Earthquake magnitude 7.0 or more |
| US | Florida | Territory 1 | Sustained wind excess of 90 mph |
| US | Florida | Territory 2 | Sustained wind excess of 100 mph |
| US | Hawaii | Territories | Sustained wind excess of 100 mph |
| | | 1&2 | |
| Japan | Tokyo | Territory A | Terrorism: damage over $900 mm. |
| UK | London | Territory A | Terrorism: damage over |
| | | | $1000 mm. |
| US | Florida | Territory A | Terrorism: damage over $700 mm. |
| US | Florida | Territory B | Terrorism: damage over $750 mm. |
| US | California | Territory A | Terrorism: damage over $500 mm. |
| US | California | Territory B | Terrorism: damage over $500 mm. |
| US | Illinois | Territory A | Terrorism: damage over $750 mm. |
| US | New York | Territory A | Terrorism: damage over $900 mm. |
| US | New York | Territory B | Terrorism: damage over $900 mm. |

TABLE 2
One Event Each 100 Years (Probability Level 2)

| | State/ | Area | |
|---|---|---|---|
| Country | Other | Description | Event Description |
| Japan | Tokyo | Territory 1 | Earthquake magnitude 8.0 or more |
| Japan | Kobe | Territory 2 | Earthquake magnitude 7.6 or more |
| US | California | Territory 1 | Earthquake magnitude 8.0 or more |
| US | California | Territory 2 | Earthquake magnitude 8.2 or more |
| US | Florida | Territory 1 | Sustained wind excess of 125 mph |
| US | Florida | Territory 2 | Sustained wind excess of 125 mph |
| US | Hawaii | Territory 1 | Sustained wind excess of 125 mph |
| US | MO and | Both States | Earthquake magnitude 7.0 or more |
| | IL | | |
| Japan | Tokyo | Territory A | Terrorism: damage over $2000 mm. |
| UK | London | Territory A | Terrorism: damage over $2500 mm. |
| US | California | Territory A | Terrorism: damage over $1000 mm. |
| US | California | Territory B | Terrorism: damage over $1000 mm. |
| US | Florida | Territory A | Terrorism: damage over $2000 mm. |
| US | Florida | Territory B | Terrorism: damage over $2000 mm. |
| US | Illinois | Territory A | Terrorism: damage over $1500 mm. |
| US | New York | Territory A | Terrorism: damage over $2000 mm. |
| US | New York | Territory B | Terrorism: damage over $2000 mm. |
| US | New York | Territory C | Terrorism: damage over $500 mm. |

TABLE 3
One Event Each 250 Years (Probability Level 3)

| | State/ | Area | |
|---|---|---|---|
| Country | Other | Description | Event Description |
| Japan | Tokyo | Territory 1 | Earthquake magnitude 9.0 or more |
| Japan | Kobe | Territory 2 | Earthquake magnitude 8.6 or more |
| US | California | Territory 1 | Earthquake magnitude 9.0 or more |
| US | California | Territory 2 | Earthquake magnitude 9.3 or more |
| US | Florida | Territory 1 | Sustained wind excess of 175 mph |
| US | Florida | Territory 2 | Sustained wind excess of 175 mph |
| US | Hawaii | Territory 1 | Sustained wind excess of 150 mph |
| US | MO and | Entire states | Earthquake magnitude 8.0 or more |
| | IL | | |
| Japan | Tokyo | Territory A | Terrorism: damage over $5000 mm. |
| UK | London | Territory A | Terrorism: damage over $7500 mm. |
| US | California | Territory A | Terrorism: damage over $2000 mm. |
| US | California | Territory B | Terrorism: damage over $2000 mm. |
| US | Florida | Territory A | Terrorism: damage over $4000 mm. |
| US | Florida | Territory B | Terrorism: damage over $4200 mm. |
| US | Illinois | Territory A | Terrorism: damage over $3500 mm. |
| US | New York | Territory A | Terrorism: damage over $5000 mm. |
| US | New York | Territory B | Terrorism: damage over $5000 mm. |
| US | New York | Territory C | Terrorism: damage over $1000 mm. |

These mappings are provided as examples only. The particular mappings will change depending on the area under consideration and the time period covered by the mapping. Exemplary definitions of the territories described in Tables 1-3 are provided in Tables 4 - 6.

TABLE 4
Definitions of Territories for Windstorm Peril

| Country | State/Other | Territory | Description |
|---|---|---|---|
| US | Hawaii | 1 | Island of Hawaii |
| US | Hawaii | 2 | Remaining islands in state |
| US | Florida | 1 | Zip codes of 33001-33500 |
| US | Florida | 2 | Zip codes of 32801-32900 |
| US | Florida | 3 | Zip codes of 33601-33800 and |
| | | | 34200-34300 |
| US | Florida | 4 | Remainder of state |

TABLE 5
Definitions of Territories for Earthquakes

| Country | State/Other | Territory | Description |
|---|---|---|---|
| US | California | 1 | Counties of Los Angeles, Ventura |
| | | | Counties of Alameda, Contra |
| | | | Costa, Marin, |
| US | California | 2 | and San Francisco |
| US | California | 3 | Remainder of state |
| US | Missouri | A | Entire state |
| US | Illinois | A | Entire state |
| Japan | Tokyo | 1 | Postal codes with prefixes 100-179 |
| Japan | Kobe | 2 | Postal codes with prefixes 650-669 |
| Japan | Remainder | 3 | Postal codes not in Territories 1 or 2 |

TABLE 6
Definitions of Territories for Terrorism

| Country | State/Other | Territory | Description |
|---|---|---|---|
| US | Hawaii | A | Entire state |
| US | Florida | A | Zip codes of 33001-33500 |
| US | Florida | B | Zip codes of 32801-32900 |
| US | Florida | C | Remainder of state |
| US | California | A | Counties of Los Angeles, Ventura |
| US | California | B | Counties of Orange, San Diego |
| US | California | C | Counties of Alameda, Contra Costa |
| | | | and San Francisco |
| US | California | D | Remainder of state |
| US | New York | A | Manhattan below 25^{th} Street |
| US | New York | B | Manhattan between 25^{th} & 116^{th} |
| | | | Streets |
| US | New York | C | Remainder of state |
| US | Illinois | A | Cook County |
| US | Illinois | B | Remainder of state |
| Japan | Tokyo | A | Postal codes with prefixes 100-179 |
| Japan | Remainder | B | |
| UK | London | A | Postal codes beginning EC1-EC4 |

It will be apparent from analyzing the zones in the Tables 1-3 that for different types of events are covered by each value of α. However, the geographic shape of the zone for each value will vary since different parts of the world have different degrees of exposure to loss from each catastrophe type. For example, an earthquake zone, including Manhattan, would be fairly large since the geographic area of Manhattan is seismically stable, but the terrorism zone including Manhattan would be relatively small since New York is a terrorist target. The size and shapes of the zones will vary as the perceived hazard levels change.

It should be understood that the estimated frequency α of each event will be set by the rules of the exchange. While it may be the case that true frequency a of each event may not be known, by establishing the relative frequencies of each type of event, the exchange will facilitate a swapping of exposures.

It should also be understood that it may be that the population of exchange members may not agree with the established frequency of an event. Each party to an exchange will have the ability to refuse a match made by the exchange, either by refusing to agree to a potential swap found by the exchange, or by failing to select a particular kind of exposure as one it is willing to swap for, even though the exchange has determined that their frequencies are the same.

It should further be understood that, if the population of exchange members does not agree with the established frequency of an event, the exchange may permit “unequal” swaps if the entities agree.

Because the zones will have the same frequency of loss, if the user entities 104 exchange the same amount of exposure, the swapped exposures will be actuarially equal in value. Thus, the expected loss from hurricane in Zone A would be the same as the expected loss from a hurricane from Zone B and the same as a loss from terrorism in Zone C.

Using the above zones, during the input phase, a user would enter a value for the amount of each exposure the user would like to swap. The search engine 108 would then search for all exposures that are actuarially equivalent. All available actuarially equivalent exposures are then displayed along with a toggle, which would then allow the user to indicate whether they would accept that exposure in exchange for the exposure the user entity wants to swap out. Then user then would select the amount of each available exposure the user is willing to swap in and the exchange would then generate contracts for the user entities involved in the swap.

Once again, if no actuarially equivalent swaps exist, the exchange 100 will present the user entity with a list of actuarially equivalent swaps from which the user would be able to select the exposures it is willing to accept if such swaps were offered in the future by other user entities 104. These would then be entered into the database 110.

While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

1. A method, comprising
receiving an offer from a first party to assume exposure to at least one type of risk in exchange for another party assuming exposure to at least one other type of catastrophic risk,
searching an offer database for an offer from a second party that is compatible with the first party's offer.

2. The method of claim 1, further comprising:
if a compatible offer is found, generating a contract between the first party and the second party in which the first party agrees to assume exposure to the at least one type of risk and the other party agrees to assume exposure to the at least one other type of catastrophic risk.

3. The method of claim 1, further comprising:
if a compatible offer is not found, storing the first party's offer in the offer database.

4. The method of claim 1, wherein the step of receiving an offer from the first party comprises:
receiving at least one type of risk that the first party is willing to assume, and
receiving at least one risk type that the first party wants to offload.

5. The method of claim 4, wherein the step of receiving at least one type of risk that the first party is willing to assume includes receiving an amount of exposure that the first party wants to assume, and wherein the step of receiving at least one risk type that the first party wants to offload includes receiving an amount of exposure that the first party wants to offload.

6. The method of claim 1, wherein the step of searching the offer database includes searching for an offer in which the first party agrees to assume exposure to a first amount of the at least one type of risk and the other party agrees to assume exposure to a second amount of the at least one other type of risk.

7. The method of claim 1, wherein the step of searching the offer database includes searching for an offer in which the first party agrees to assume exposure to a first amount of the at least one type of risk and the other party agrees to assume exposure to a second amount of the at least one other type of risk.

8. The method of claim 1, wherein the step of receiving an offer from the first party includes receiving an offer that includes a first duration for which the first party is to assume exposure to the at least one type of risk and a second duration for which the second party is willing to assume exposure to the at least one other type of risk.

9. The method of claim 1, wherein the first duration and the second duration are equal.

10. The method of claim 1, further comprising:
classifying a plurality of events as part of a plurality of predetermined risk zones.

11. The method of claim 10, wherein the step of receiving an offer from the first party includes receiving an offer from the first party to assume exposure to a risk that is classified in one of the risk zones in exchange for a second party agreeing to assume exposure to a risk that is classified in another one of the risk zones.

12. The method of claim 10, wherein the step of classifying includes determining, for each of a plurality of geographic areas, the frequency in which it is expected that each of a plurality of types of events will occur.

13. An article, comprising:
a computer-readable signal-bearing medium;
logic in the medium for receiving an offer from a first party to assume exposure to at least one type of risk in exchange for another party assuming exposure to at least one other type of catastrophic risk,
logic in the medium for searching an offer database for an offer from a second party that is compatible with the first party's offer.

14. The article of claim 13, further comprising:
logic in the medium for generating a contract between the first party and the second party in which the first party agrees to assume exposure to the at least one type of risk and the other party agrees to assume exposure to the at least one other type of risk if the offer of the first party is compatible with the offer of the second party.

15. The article of claim 13, further comprising:
logic in the medium for storing the first party's offer in the offer database if a compatible offer is not found.

16. The article of claim 13, wherein the means in the medium for receiving an offer from the first party comprises:
logic in the medium for receiving at least one type of risk that the first party is willing to assume, and
logic in the medium for receiving at least one risk type that the first party wants to offload.

17. The article of claim 16, wherein the logic in the medium for receiving at least one type of risk that the first party is willing to assume includes means in the medium for receiving an amount of exposure that the first party wants to assume, and wherein the means in the medium for receiving at least one risk type that the first party wants to offload includes means in the medium for receiving an amount of exposure that the first party wants to offload.

18. The article of claim 13, wherein the logic in the medium for searching the offer database includes logic in the medium for searching for an offer in which the first party agrees to assume exposure to a first amount of the at least one type of risk and the other party agrees to assume exposure to a second amount of the at least one other type of risk.

19. The article of claim 13, wherein the logic in the medium for searching the offer database includes logic in the medium for searching for an offer in which the first party agrees to assume exposure to a first amount of the at least one type of risk and the other party agrees to assume exposure to a second amount of the at least one other type of risk.

20. The article of claim 13, wherein the logic in the medium for receiving an offer from the first party includes means in the medium for receiving an offer that includes a first duration for which the first party is to assume exposure to the at least one type of risk and a second duration for which the second party is willing to assume exposure to the at least one other type of risk.

21. The article of claim 13, wherein the first duration and the second duration are equal.

22. The article of claim 13, further comprising:
logic in the medium for classifying a plurality of events as part of a plurality of predetermined risk zones.

23. The article of claim 22, wherein the logic in the medium for receiving an offer from the first party includes logic in the medium for receiving an offer from the first party to assume exposure to a risk that is classified in one of the risk zones in exchange for a second party agreeing to assume exposure to a risk that is classified in another one of the risk zones.

24. The method of claim 22, wherein the means in the medium for classifying includes means in the medium for determining, for each of a plurality of geographic areas, the frequency in which it is expected that each of a plurality of types of catastrophic events will occur.

25. A system, comprising:
an offer database that includes at least one offer from a party to assume exposure to at least one type of catastrophic risk in exchange for another party assuming exposure to at least one other type of catastrophic risk;
an interface to receive offers to trade exposure to catastrophic risks; and
search logic to match received offers to trade catastrophic risks to offers in the offer database.

26. A method, comprising:
sending an offer to an exchange agreeing to assume exposure to at least one type of catastrophic risk in exchange for another party assuming exposure to at least one other type of catastrophic risk,
receiving a communication from the exchange providing results from a search of an offer database for an offer from a second party that is compatible with the offer.

27. The method of claim 25, wherein the step of receiving the communication includes receiving an indication that a match has been found between the offer and an offer from the second party, the method further comprising:
forming a contract with the second party agreeing to assume exposure to the at least one type of catastrophic risk in exchange for the other party assuming exposure to the at least one other type of catastrophic risk.

28. The method of claim 25, wherein the step of receiving the communication includes receiving an indication that a match has not been found between the offer and an offer in the database, the method further comprising:
agreeing to store the offer in the offer database.
